(19) United States
(12) Patent Application Publication
(10) Pub. No.: US 2016/0291748 A1
(43) Pub. Date: Oct. 6, 2016

(54) TOUCH DISPLAY DEVICE UTLIZING EXTRA CONDUCTIVE LAYER ON THIN FILM TRANSISTOR TO DETECT TOUCH OPERATION

(71) Applicant: Century Technology (Shenzhen) Corporation, Shenzhen (CN)

(72) Inventors: MING-TSUNG WANG, New Taipei (TW); CHIH-CHUNG LIU, New Taipei (TW); YI-HSIU CHENG, New Taipei (TW); WEN-QIANG YU, Shenzhen (CN)

(21) Appl. No.: 14/715,257

(22) Filed: May 18, 2015

(30) Foreign Application Priority Data
Apr. 3, 2015 (CN) 201510156689.1

(51) Int. Cl. G06F 3/041

(52) U.S. Cl. CPC G06F 3/0412

(57) ABSTRACT

A touch display device includes a thin film transistor (TFT) array substrate and an opposite substrate opposite to the TFT array substrate. The TFT array substrate includes a plurality of gate lines, a plurality of data lines, and a plurality of TFTs. Each TFT includes a gate coupled to a corresponding gate line, a source coupled to a corresponding data line, a channel layer located corresponding with the gate, and a conductive layer located corresponding with the channel layer. The gate and the source are respectively coupled with the channel layer. The opposite substrate includes a common electrode layer. When a touch operation is applied to the touch display device, the opposite substrate is deformed to make the common electrode layer to couple with the conductive layer of at least one of the TFT, to detect the touch operation.

### CROSS-REFERENCE TO RELATED APPLICATIONS

This application claims priority to Chinese Patent Application No. 201510156689.1 filed on Apr. 3, 2015 in the Chinese Intellectual Property Office, the contents of which are incorporated by reference herein.

### FIELD

The subject matter herein generally relates to a touch display device which utilizes an extra conductive layer on thin film transistors to detection touch operations.

### BACKGROUND

Generally, a touch display device may include a touch module and a display module. Usually, the touch module and the display module are manufactured respectively. The touch module and the display module can be assembled together using adhesive materials, such as optical clear adhesives (OCA).

### BRIEF DESCRIPTION OF THE DRAWINGS

Implementations of the present technology will now be described, by way of example only, with reference to the attached figures.

FIG. 1 is an isometric view of a touch display device.

FIG. 2 is a diagrammatic view of a thin film transistor (TFT) array substrate of FIG. 1.

FIG. 3 is an enlarged view of a circled region III in FIG. 2.

FIG. 4 is a cross-sectional view of the touch display device of FIG. 1.

FIG. 5 is diagrammatic view of the touch display device when a touch operation is applied on the touch display device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “coupled” is defined as connected, whether directly or indirectly through intervening components, and is not necessarily limited to physical connections. The connection can be such that the objects are permanently connected or releasably connected. The term “comprising”, when utilized, means “including, but not necessarily limited to”; it specifically indicates open-ended inclusion or membership in the so-described combination, group, series and the like.

The present disclosure is described in relation to a touch display device which utilizes an extra conductive layer on thin film transistors to detection touch operations.

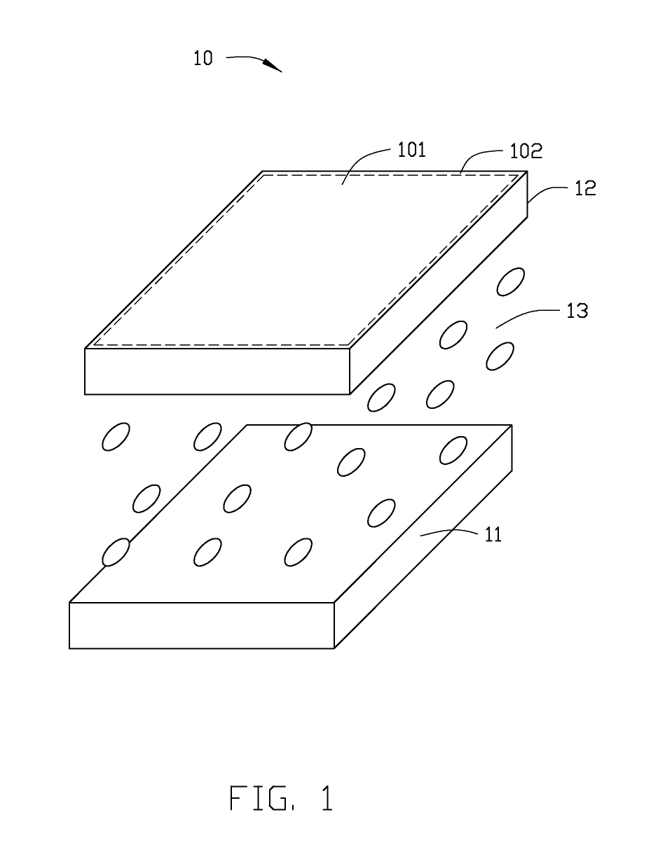

Referring to FIG. 1, FIG. 1 is an isometric view of a touch display device 10. The touch display device 10 includes a thin film transistor (TFT) array substrate 11, an opposite substrate 12 opposite to the TFT array substrate 11, and a liquid crystal layer 13 located between the TFT array substrate 11 and the opposite substrate 12. The touch display device 10 includes an active area (AA) 101 and a non-active area 102 surrounding the active area 101. The active area 101 is configured to display information (e.g., images, icons, texts, and videos) and to detect touch operations applied thereon. The active area 101 can be a rectangular area. The non-active area 102 can be a frame composed of four sides connected end to end.

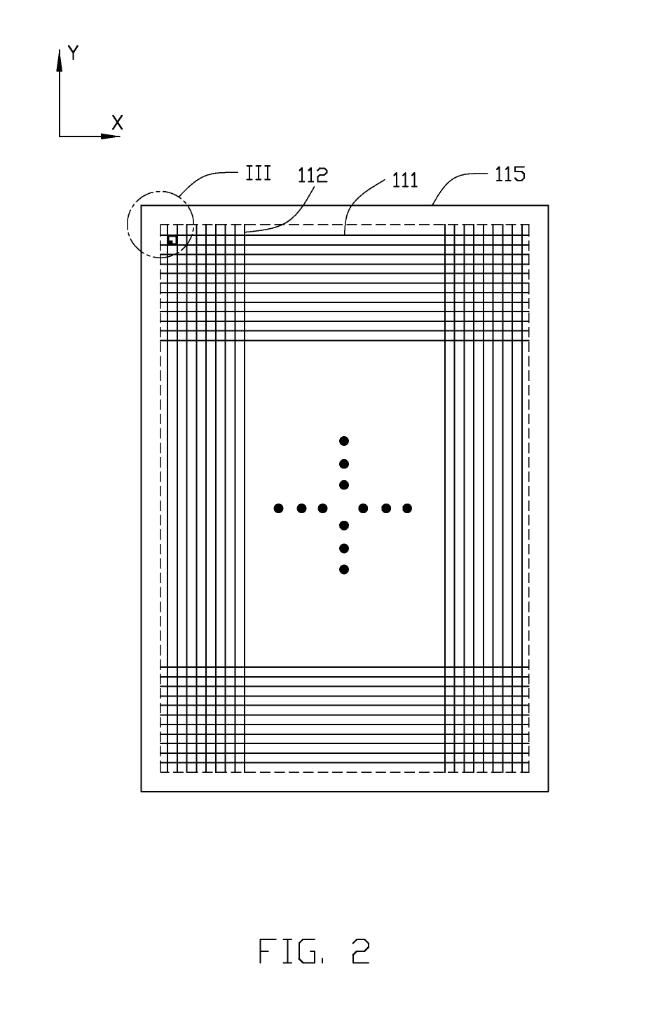

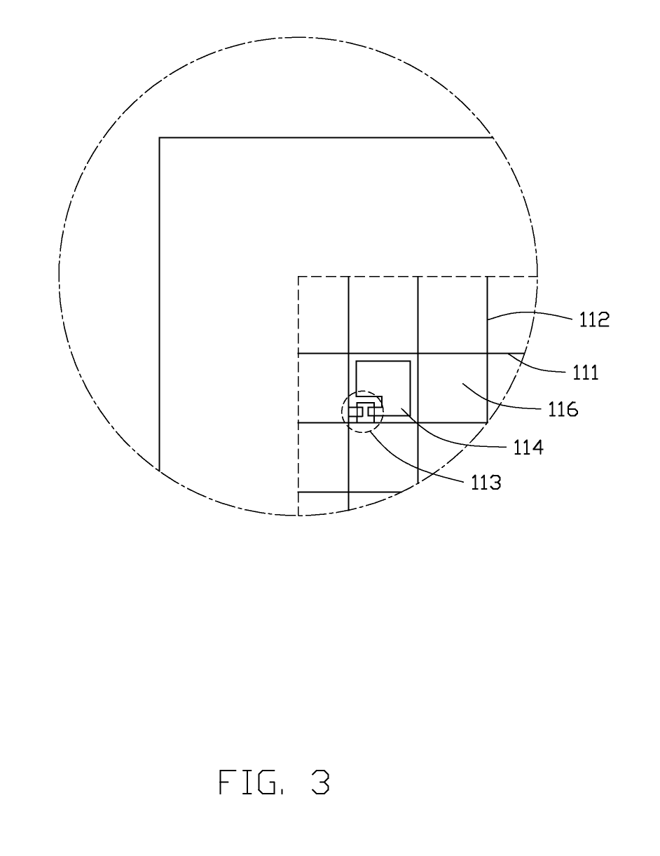

Referring to FIG. 2 and FIG. 3, FIG. 2 is a diagrammatic view of a thin film transistor (TFT) array substrate of FIG. 1, FIG. 3 is an enlarged view of a circled region III in FIG. 2. The TFT array substrate includes a plurality of gate lines 111, a plurality of data lines 112, a plurality of TFTs 113, a plurality of pixel electrodes 114, and a first substrate 115. The gate lines 111 and the data lines 112 are intersected with each other to define a plurality of pixels areas 116. In at least one embodiment, the gate lines 111 are arranged in parallel, and the data lines 112 are arrange in parallel as well as the gate lines 111. The gate lines 111 extend along a first direction while the data lines extend along a second direction perpendicular with the first direction. Thus, the pixel area 116 is rectangular. Each pixel electrode 114 is located within a corresponding pixel area 116 and is electrically coupled to a corresponding TFT 113. The pixel electrode 114 can be made of transparent materials, such as indium tin oxide (ITO). The first substrate 115 can be made of rigid and transparent inorganic materials, such as glass, quartz, or other like materials. In other embodiments, the first substrate 11 can also be made of flexible organic materials, such as plastics, rubbers, polyesters, or other like materials.

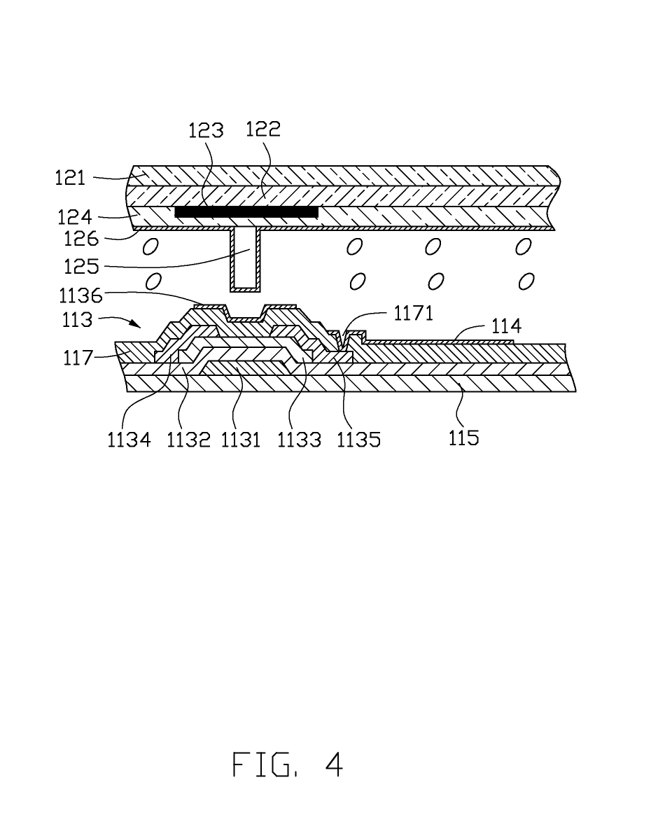

Referring to FIG. 4, FIG. 4 is a cross-sectional view of the touch display device of FIG. 1. The TFT 113 includes a gate 1131, a gate insulation layer 1132, a channel layer 1133, a source 1134, a drain 1135, and a conductive layer 1136. The gate 1131 is located on the first substrate 115. The gate insulation layer 1132 is located on and covers the first substrate 115 and the gate 1131. The channel layer 1133 is located on the gate insulation layer 1132 and corresponds with the gate 1131. The source 1134 and the drain 1135 are respectively located at two opposite sides of the channel layer 1133.

The TFT array substrate 11 further includes a passivation layer 117 located on and covers the TFT 113. In addition, the passivation layer 117 covers the gate insulation layer 1132, the channel layer 1133, the source 1134, and the drain 1135. The passivation layer 117 defines a through hole 1171 corresponding with the drain 1135. The pixel electrode 114 is located on the passivation layer 117 and electrically coupled to the drain 1135 via the through hole 1171. The conductive layer 1136 is located on the passivation 117 to correspond with the channel layer 1133. The conductive layer 1136 is isolated from the source 1134 and the drain 1135 via the passivation layer 117. Thus, both the conductive layer 1136 and the pixel electrode 114 are located on the passivation layer 117, and they are separated from each other. The conductive layer 1136 and the pixel electrode 114 are made of the same materials and thy can be manufactured in a single manufacturing process. In other embodiment, the conductive layer 1136 and the pixel electrode 114 can be made of different materials, respectively. For example, the pixel electrode 114 can be made of transparent conductive materials, and the conductive layer 1136 can be made of non-transparent conductive materials, such as metals.

The opposite substrate 12 includes a second substrate 121, a color photoresist layer 122, a black matrix 123, a flat layer 124, a photo spacer 125, and a common electrode layer 126. The color photoresist layer 122, the black matrix 123, the flat layer 124, the photo spacer 125, and the common electrode layer 126 are located on the second substrate 121. The color photoresist layer 122 is located at a side of the second substrate 121 adjacent to the liquid crystal layer 13. The black matrix 123 is located at a side of the color photoresist layer 122 away from the second substrate 121. The black matrix 123 corresponds with the TFT 113 to shield the TFT 113 to avoiding light leakage issues. The color photoresist layer 122 and the black matrix 123 jointly form a color filter of the touch display device 10. The flat layer 124 covers the color photoresist layer 122 and the black matrix 123. The photo spacer 125 is located on the flat layer 124 and corresponds with the conductive layer 1136 located on the TFT array substrate 11. The photo spacer 126 is not contacted with the conductive layer 1136 if no external force is applied to the touch display device 10. The common electrode layer 126 is located at a side of the flat layer 124 adjacent to the liquid crystal layer 123 and covers the flat layer 124 and the photo spacer 125. In at least one embodiment, a distance between the photo spacer 125 and the conductive layer 1136 is greater than a thickness of the common electrode layer 126. The common electrode layer 126 is configured to work with the pixel electrode 114 of the TFT array substrate 11 to produce an electrical field for driving liquid crystals of the liquid crystal layer 13 to rotate. In at least one embodiment, the common electrode layer 126 can be made of the same materials with the pixel electrode 114. For example, the materials can be transparent materials such as ITO. The second substrate 121 can be made of rigid and transparent inorganic materials, such as glass, quartz, or other like materials. In other embodiments, the second substrate 121 can also be made of flexible organic materials, such as plastics, rubbers, polyesters, or other like materials.

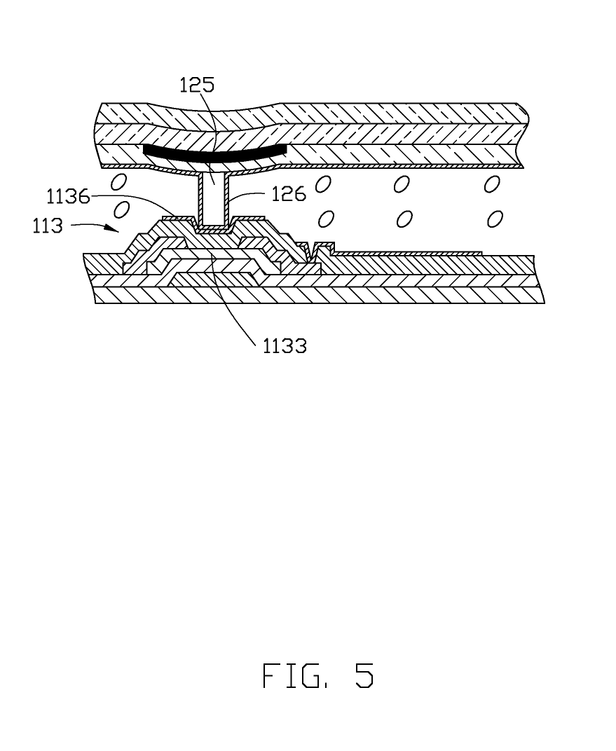

Referring to FIG. 5, FIG. 5 is diagrammatic cross-sectional view of the touch display device 10 when a touch operation is applied on the touch display device 10. In a touch scanning period of the touch display device 10, a touch scanning signal is transmitted to the TFT 11 via the gate line 111 to turn on the TFT 113. At this time, the data line 112 is supplied with a voltage by an external circuit. When a touch operation is applied on the touch display device 10, the opposite substrate 12 is deformed by an external force from the touch operation to push the photo spacer 125 to move towards the TFT array substrate 11 until the common electrode layer 126 contacts with the conductive layer 1136. Then, the common electrode layer 126 supplies a voltage to the conductive layer 1136. At the same time, the data line 112 applies a data signal to the source 1134 of the TFT 113. Since the conductive layer 1136 is applied with a voltage, an electric field is formed between the conductive layer 1136 and the gate 1131, and a current passing through the channel layer 1133 is changed by the electric field. The data line 112 generates and transmits a feedback signal indicating a change of the current passing through the channel layer 1133 to a detecting circuit (e.g., a touch IC) of the touch display device 10. Thus, the detecting circuit (not shown) can detect a position of the touch operation on the touch display device 10 according to the feedback signal of the data line 112. That is, the position of the touch operation can be detected by detecting the current passing through the channel layer 1133 of each of the TFTs 113. Since the opposite substrate 12 needs to be deformed to detect the touch operation, the second substrate 121 can be a flexible substrate.

When the touch operation applied on the touch display device 10 disappears, the deformation of the opposite substrate 12 would recover to disconnect the common electrode layer 126 and the conductive layer 1136.

In at least one embodiment, in the touch period of the touch display device 10, the gate line 111 serves as a touch scanning electrode and the data line 112 serves as a touch detection electrode. The voltage supplied to the data line 112 can be a pulsed voltage. In a display period of the touch display device 10, the common electrode layer 126 is separated from the conductive layer 1136 and works with the pixel electrode 114 to realize a display function.

As described above, an extra conductive layer 1136 is formed on the TFT 113 of the TFT array substrate 11 to detect touch operations. Thus, the touch module can be omitted to reduce the cost the touch display device 10.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A touch display device comprising:
a thin film transistor (TFT) array substrate comprising a plurality of gate lines, a plurality of data lines, a plurality of TFTs, each TFT comprising a gate coupled to a corresponding gate line, a source coupled to a corresponding data line, a channel layer corresponding with the gate, and a conductive layer corresponding with the channel layer; the gate and the source respectively coupled with the channel layer; and
an opposite substrate opposite to the TFT array substrate and comprising a common electrode layer;
the touch display device configured such that when a touch operation is applied to the touch display device, the opposite substrate is deformed to push the common electrode layer to move towards the TFT array substrate to couple with the conductive layer of at least one of the TFTs, each of the gate lines is supplied with a touch scanning signal to turn on the TFTs, and each of the data lines is supplied with a voltage and provides a feedback signal to detect the touch operation.

2. The touch display device according to claim 1, wherein the voltage supplied to each of the data lines is a pulsed voltage.

3. The touch display device according to claim 1, wherein the TFT array substrate further comprises a first substrate; the TFT further comprises a gate insulation layer and a passivation layer; the gate is located on the first substrate, and the gate insulation layer is located on and covers the first substrate and the gate; the channel layer is located on the gate insulation layer, and the source and the drain are respectively located at opposite sides of the channel layer; the passivation layer covers the gate insulation layer, the channel layer, the source, and the drain; and the conductive layer is located on the passivation layer.

4. The touch display device according to claim 3, wherein gate lines and the data lines are intersected with each other to define a plurality of pixel areas; the TFT array substrate further comprises a plurality of pixel electrodes corresponding to the pixel areas; each pixel electrode is located on the passivation layer of a corresponding TFT and is electrically coupled to the drain of the corresponding TFT via a through hole defined on the passivation layer.

5. The touch display device according to claim 4, wherein the conductive layer is located on the passivation layer as well as the pixel electrode.

6. The touch display device according to claim 5, wherein the conductive layer and the pixel electrode are made of the same materials in a single manufacturing process.

7. The touch display device according to claim 6, wherein the conductive layer and the pixel electrode are made of transparent materials.

8. The touch display device according to claim 7, wherein the conductive layer and the pixel electrode are made of indium tin oxides.

9. The touch display device according to claim 5, wherein the conductive layer and the pixel electrode are made of different materials.

10. The touch display device according to claim 9, wherein the conductive layer is made of non-transparent conductive materials and the pixel electrode is made of transparent materials.

11. The touch display device according to claim 3, wherein the opposite substrate further comprises a second substrate, a color photoresist layer, a black matrix, a flat layer, and a photo spacer; the color photoresist layer, the black matrix, the flat layer, the photo spacer, and the common electrode layer are located on the second substrate; the color photoresist layer is located at a side of the second substrate adjacent to a liquid crystal layer of the touch display device; the black matrix is located at a side of the color photoresist layer away from the second substrate; the flat layer covers the color photoresist layer and the black matrix; the photo spacer is located on the flat layer and corresponds with the conductive layer; the common electrode layer is located at a side of the flat layer adjacent to the liquid crystal layer and covers the flat layer and the photo spacer.

12. The touch display device according to claim 11, wherein the conductive layer and the common electrode layer are disconnected from each other when no touch operation is applied on the touch display device.

13. The touch display device according to claim 11, wherein the second substrate is a flexible substrate.

14. The touch display device according to claim 11, wherein the color photoresist layer and the black matrix jointly form a color filter of the touch display device.

15. The touch display device according to claim 1, wherein an electric field is formed between the conductive layer and the gate and a current passing through the channel layer is changed by the electric field, when the conductive layer of the at least one of the TFTs is coupled with the common electrode layer; and a corresponding data line generates the feedback signal indicating a change of the current passing through the channel layer to detect the touch operation.
